(19) United States
(12) Patent Application Publication
(10) Pub. No.: US 2018/0034271 A1
(43) Pub. Date: Feb. 1, 2018

(54) HOME CHARGING AND POWER BACK UP UNIT

(71) Applicant: Detroit Electric EV Ltd., Jiagngsu Province (CN)

(72) Inventor: Albert Lam, Jiangsu Province (CN)

(21) Appl. No.: 15/719,439

(22) Filed: Sep. 28, 2017

Related U.S. Application Data
(63) Continuation-in-part of application No. 14/674,342, filed on Mar. 31, 2015.
(60) Provisional application No. 61/973,751, filed on Apr. 1, 2014.

(51) Int. Cl. H02J 3/00; H02J 50/12; H02J 7/04; B60L 11/18

(52) U.S. Cl. CPC H02J 3/005; B60L 11/1842; H02J 50/12; H02J 7/04

(57) ABSTRACT

A power switching unit for use with a power grid, a home power network, and a vehicle power network. A first power port is connectable to the power grid to receive power therefrom, a second power port is connectable to the vehicle power network, and a third power port is connectable with the home power network. A switch is in electrical communication with the first, second and third power ports, with the switch being transitional between first and second positions. In the first position, the switch places the first power port in electrical communication with the second and third power ports to enable the power grid to provide power to the vehicle power network and the home power network. In the second position, the switch places the second power port in electrical communication with the third power port, allowing the vehicle to provide power to the house power port.

### CROSS-REFERENCE TO RELATED APPLICATIONS

The present application is a continuation-in-part of an earlier U.S. patent application Ser. No. 14/674,342 filed Mar. 31, 2015, wherein the earlier U.S. patent application Ser. No. 14/674,342 claims the benefit of U.S. Provisional Patent Application Ser. No. 61/973,751, filed Apr. 1, 2014, the contents of which are expressly incorporated herein by reference.

### STATEMENT RE: FEDERALLY SPONSORED RESEARCH/DEVELOPMENT

Not Applicable

### BACKGROUND

### 1. Technical Field:

The present disclosure relates generally to a home charging and power backup unit, namely a power supply management device for a home, and more specifically, to a device capable of monitoring the supply of power from a power grid, drawing power from an electrical vehicle and supplying the power to the home in the event of power loss from the power grid.

### 2. Description of the Related Art

Electrical vehicles have grown in popularity in recent years due to their desirable fuel economy and their reduced emissions relative to conventional internal combustion vehicles. Electrical vehicles are typically powered by one or more electric motors, which use energy stored in on-board batteries for driving the one or more electric motors. After driving an electrical vehicle for a period of time, the energy stored in the batteries becomes depleted, and therefore, electrical vehicles are designed to be recharged to replenish the stored energy in the batteries.

Recharging batteries in a given electrical vehicle typically occurs by connecting a power cable having a specially designed socket to a corresponding outlet formed on the electrical vehicle. Typically, an owner of an electrical vehicle will have a charging cable at his/her home to allow the owner's electrical vehicle to recharge when the electrical vehicle is parked at home. In addition to charging at one's home, there has been a rapidly expanding network of public charging stations, which has made it easier to charge electrical vehicles away from the home. For instance, government agencies, automakers, charging equipment manufacturers, and so forth, have contributed to the growing number of public charging stations.

It is understood that in some instances, a power grid supplying power to the home may experience a power loss. For instance, a severe weather event may cause a power loss, or the power loss may also be caused by an overload on the power grid, as commonly occurs during hot summer months. In most instances, the power grid is a sole supply of power to the home and also a sole supply of power for recharging the electrical vehicle in the home; thus, when power is no longer supplied from the grid, the home experiences a power outage and the electrical vehicle stops recharging. A power loss from the power grid is typically a very undesirable occurrence since most households are dependent on the power grid to provide electricity for such basic needs as lighting, warm water, and refrigerated food. In winter and summer months, the home may also use electricity from the power grid to power a heater or air conditioner to maintain a safe and comfortable temperature within the home.

Batteries in an electrical vehicle located at a given home experiencing a power loss may have a sufficient amount of stored power to provide electricity to the home. For instance, the power loss may occur after the batteries in the electrical vehicle have completely recharged. Furthermore, in view of prevalence of publically available charging stations, the battery power of the electrical vehicles may not be as depleted when the vehicles return to the home, and as such, even if the power loss occurs shortly after the vehicle returns to the home, the vehicle batteries may still have a useful amount of stored power, for example, 20% of their fully recharged capacity. Accordingly, an electrical vehicle located at a home experiencing a power loss may be a useful source of supplemental electrical energy. However, a conventional connection between the electrical network in the home and the vehicle allows power flow only in one way, namely, from the home to the vehicle, not from the vehicle to the home.

Accordingly, there is a need in the art for a power management device which monitors the supply of power from a power grid to a home, and draws power from an electrical vehicle for supply to the home in the event of a power loss from the power grid. Various aspects of the present disclosure address this particular need, as will be discussed in more detail below.

Accordingly, there also arises a need in the art for operators of a power grid to have additional resources of stored energy that can be deployed when the power grid is becoming overloaded, to try to maintain a reliable supply of electrical power to customers supplied with electrical power from the power grid, for example in an event of unexpected failure in a hydroelectric power generating station, a nuclear power plant, a solar radiation power plant or similar.

### BRIEF SUMMARY

In accordance with the present disclosure, there is provided a device and corresponding method for managing the communication of power to a home from an external power source. In a first, normal, operational mode, power is delivered from a power grid to a rechargeable vehicle and the home. However, in the event of power loss from the power grid, stored power is drawn from the vehicle and is supplied to the home to mitigate the consequences of grid power loss.

Moreover, in accordance with the present disclosure, there is provided a device and corresponding method for managing the communication of power from a rechargeable vehicle to a power grid, to provide a power resource to the power grid in an event of the power grid needing assistance to maintain operation of the power grid, for example in an event of there being a risk that the power grid becomes overloaded in operation.

According to one embodiment, there is provided a power switching unit adapted for use with a power grid, a home power network, and a vehicle having a vehicle power network. The power switching unit includes a first power port configured to be connectable to the power grid to receive power therefrom, a second power port configured to be connectable to the vehicle power network, and a third power port configured to be connectable with the home power network. A switch is in electrical communication with the first power port, the second power port, and the third power port, with the switch being transitional between a first position and a second position. In the first position, the switch places the first power port in electrical communication with the second power port and the third power port to enable the power grid to provide power to the vehicle power network and the home power network. In the second position, the switch places the second power port in electrical communication with the third power port, to allow the electrical vehicle to provide power to the house power port.

The first power port may be configured to detect a power loss from the power grid. The switch may be configured to switch automatically from the first position to the second position in response to a detected power loss by the first power port. The switch may also be configured to switch automatically from the second position to the first position in response to detection of power from the power grid. The switch may be configured to isolate the first power port from the second power port and the third power port when the switch is in the second position.

The power switching unit may additionally include a user input circuit adapted to receive a switch signal from a user, with the switch being configured to switch modes in response to receipt of the switch signal. The user input circuit may include a wireless communication circuit capable of receiving the switch signal via wireless communication.

The first power port may be configured to receive 100-240V AC from the power grid. The second power port may be configured to transmit 100-240V AC to the vehicle power network when the switch is in the first mode, and receive 100-240V AC from the vehicle power network when the switch is in the second mode. The second power port may be an IEC 62196 connector.

The power switching unit may further include a control unit capable of generating a command signal to the vehicle power network to provide power to the second power port.

According to another embodiment, there is provided a method of managing the communication of electrical power between a power grid, a vehicle power network, and a home power network. The method includes receiving electrical power from the power grid at a first power port. The electrical power received from the power grid is delivered to a second power port adapted to communicate electrical power to the vehicle power network for charging the vehicle, and a third power port adapted to communicate electrical power to the home power network. The method further includes the step of detecting a loss of electrical power from the power grid at the first power port, and receiving electrical power from the vehicle power network at the second power port subsequent to the detected loss of electrical power from the power grid. The electrical power received at the second power port is delivered to the third power port for supplying electrical power to the home.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a system level overview of a power management system constructed in accordance with an embodiment of the present disclosure;

FIG. 2 is a schematic diagram of the power management system shown in FIG. 1; and

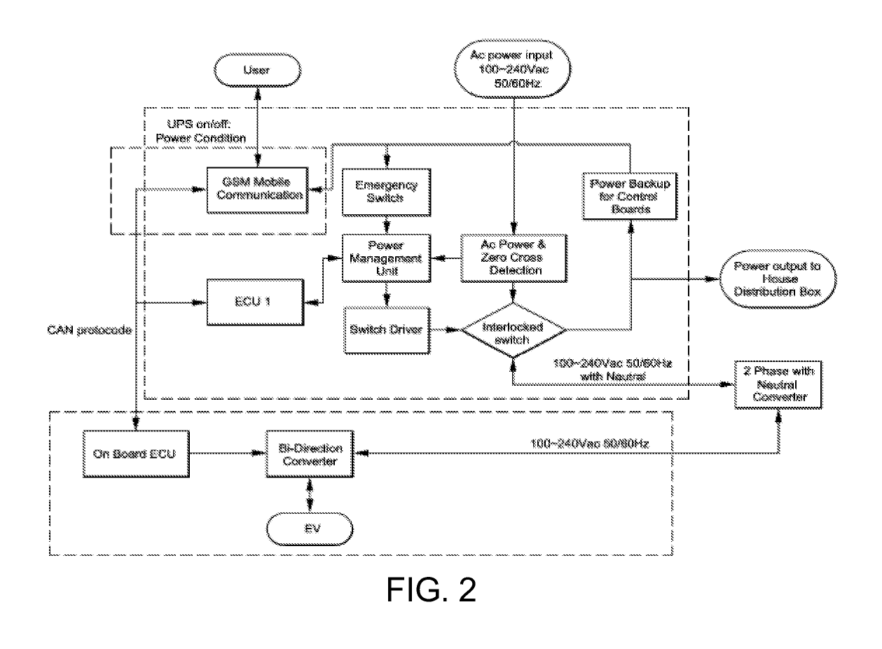

FIG. 3 is a schematic diagram of a power switching unit constructed in accordance with an embodiment of the present disclosure.

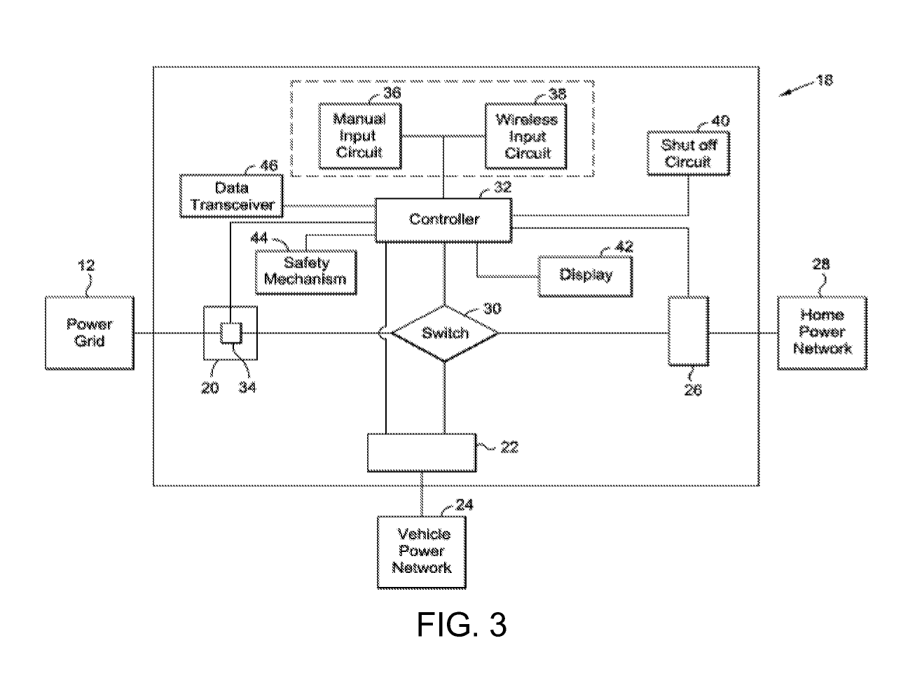

Common reference numerals are used throughout the drawings and the detailed description to indicate the same elements.

### DETAILED DESCRIPTION

The detailed description set forth below in connection with the appended drawings is intended as a description of certain embodiments of a power management system for use with an electrical vehicle and is not intended to represent the only forms that may be developed or utilized. The description sets forth the various structures and/or functions in connection with the illustrated embodiments, but it is to be understood, however, that the same or equivalent structures and/or functions may be accomplished by different embodiments that are also intended to be encompassed within the scope of the present disclosure. It is further understood that the use of relational terms such as first and second, and the like are used solely to distinguish one entity from another without necessarily requiring or implying any actual such relationship or order between such entities. Additionally, as used herein, the term “power” is intended to mean electrical power, electrical energy or electricity.

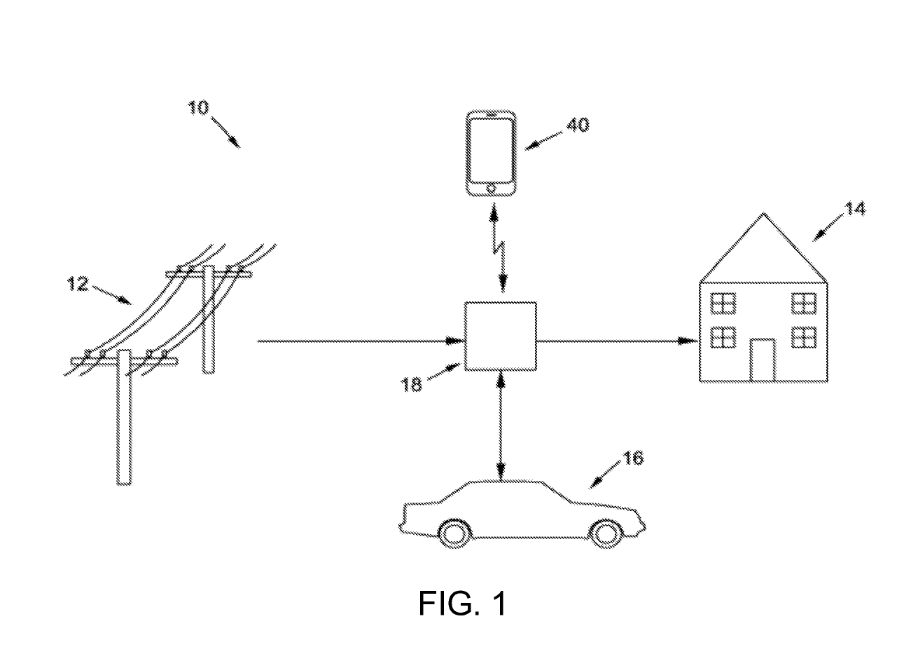

In FIG. 1, there is shown an illustration depicting a power management system 10 for managing a power flow between a power grid 12, a home 14, and an electrical vehicle 16. As will be described in more detail below, the power flow is managed through a power switching unit 18 which is in electrical communication with the power grid 12, the home 14, and the electrical vehicle 16. There is also provided a data communication network between the power switching unit 18 and a control system (not shown) that is operable to manage operation of the power grid 12, for example, for ensuring that the power grid 12 is operated within certain prescribed voltage and frequency ranges, as experienced by customers of the power grid 12. During normal conditions, namely when power is being received from the power grid 12, the power switching unit 18 delivers received power from the power grid 12 to the electrical vehicle 16 for recharging the electrical vehicle 16, as well as delivering power to the home 14 for providing power to the electrical appliances therein. However, in the event of a power outage which results in power loss from the power grid 12, the power switching unit 18 draws stored power from the electrical vehicle 16 and delivers that vehicle power to the home 14. Accordingly, the power switching unit 16 may allow an owner of an electrical vehicle 16 to tap into the stored energy of the electrical vehicle 16 in the event of a main power loss from the power grid 12. Therefore, the electrical vehicle 16 may serve as a backup power source to the home 14.

When the electrical vehicle 16 is operable to provide power to the home 14, in the event of the main power loss from the power grid 12, the electrical vehicle 16 is operable to synthesize an alternating current (A.C.) supply that mimics power provided by the power grid 12 when connected to the home. In an event that the control system (not shown) of the power grid 12 can predict a duration of the main power loss, such information is communicated via the data communication network to the electrical vehicle 16 and to the home 14, so that a data processing system of the electrical vehicle 16 (referred to as “Smartphone Application Managed Infotainment” System or “SAMI”) or a data processing system of the home 14 (referred to as “smart home control hub”), for example collectively the power management system 10, or a combination of both data processing systems, is operable to manage a rate of power utilization from the electrical vehicle 16, for ensuring that the home 14 is provided with a continuous supply of power during a period of the main power loss. For example, one or more of the data processing systems are operable to switch off non-essential electrical equipment in the home 14, if batteries of the electrical vehicle 16 are estimated to have insufficient power stored therein to provide power to the home 14 with the non-essential electrical equipment remaining in a state of consuming power. For example, non-essential equipment in the home 14 includes aesthetic comfort lighting, electrical heaters in rooms not being occupied by persons or animals, electrical appliances (for example, washing machines, tumble driers, and hot water immersion heaters) whose operation can be delayed until an end of the period of the main power loss. Such non-essential equipment is conveniently implemented as smart equipment with on-board data microcontrollers and associated wireless communication devices (for example, Bluetooth® devices, or similar near-field wireless communication devices) for communicating to the data processing arrangement (“SAMI”) of the electrical vehicle 16, or the data processing system of the home 14, or both. For example, one or more of the data processing systems are operable to switch-off the smart equipment in a selective manner to conserve power in an event that the batteries of the electrical vehicle 16 approach exhaustion and there is still a long period of time before an end of the main power loss. Optionally, one or more of the data processing systems are operable, for example via a user interface, to provide an opportunity for a user to select manually those electrical appliances that can be optionally switched off in the home 14 to conserve power, and those electrical appliances that must be allowed to remain provided with power. Optionally, the user interface provides for prioritizing an order in which electrical appliances of the home 14 are to be switched off in order to conserve power, for example during an unexpected prolonged period of main power loss.

As aforementioned, the electrical vehicle 16 includes one or more semiconductor power modules for synthesizing mains electrical A.C. (“alternating current”) power for suppling from the batteries of the electrical vehicle 16 to the home 14. The one or more semiconductor power modules are optionally synchronized in operation to a master clock of the power grid 12, so that seamless switching between A.C. power provided from the electrical vehicle 16 and A.C. power from the power grid 12 can be achieved in operation, for example at the end of the main power loss. Alternatively, or additionally, the one or more power modules are operable to synthesize A.C. power to mimic the power that is normally supplied to the home 14 from the power grid 12, by the one or more modules having an internal clock or frequency reference. For example, the one or more power modules are operable to synthesize A.C. power with a frequency of 50/60 Hz. Furthermore, such power provided from the electric vehicle may be directly used for charging and/or operating appliances located in the home such as kitchen appliances, smartphones, electric toothbrushes and so forth. The one or more modules beneficially employ high-frequency switching circuits, for example based upon use of MOSFETs and/or Silicon Carbide FETs, for example employing high-frequency PWM (“pulse width modulated”) switching techniques. Silicon Carbide FETs are beneficial to employ in that they are capable of switching high voltages, for example in excess of 1 kV, at very high frequencies, for example at several MHz, and at high currents, for example 100 Amperes, that enable relatively small ferrite or air-cored transformers to be employed when transforming a potential of the battery, or the plurality of batteries, of the electrical vehicle 16 to synthesize mains power for the home 14, and also when providing power from the power grid 12 for recharging the battery, or the plurality of batteries, of the electrical vehicle 16. Such relatively small ferrite or air-cored transformers enables a weight and size of circuits associated with the power management system 10 to be more compact and lighter in weight.

As used herein, the term “power grid” refers to an interconnected network for delivering electricity from one or more suppliers to one or more customers. The supplier may be a utility company which generates the electricity at a power station, for example nuclear fission reactors, hydroelectric power generators, wind farms, solar panel farms, tidal power generator, ocean wave generators, geothermal power generators, coal-fired power stations, and so forth.

As used herein, the term “electrical vehicle” refers to any vehicle having stored electrical energy, including those vehicles that are capable of being charged from an external electrical power source. This may include electrical vehicles having batteries which are exclusively charged from an external power source, as well as hybrid-vehicles which may include batteries that are capable of being at least partially recharged via an external power source.

The ability to switch the source of power to the home 14 is made possible by the power switching unit 18, which includes a power grid port 20 connectable to the power grid 12, a vehicle port 22 connectable to a vehicle power network 24 associated with the vehicle 16, and a home port 26 connectable to a home power network 28 associated with the home 14. The vehicle power network 24 includes the battery, or a plurality of batteries, located on the vehicle 16, which provides power to the electrical vehicle's electrical systems. The vehicle power network 24 may further include a plug or connector for connecting the vehicle power network 24 to an external power source for recharging the battery, or the plurality of batteries. The home power network 28 generally includes the home's electrical network which is capable of distributing received electrical energy to electrical outlets and appliances located in the home 14.

The power grid port 20 and the house port 26 may include terminals which are hard wired to the power grid 12 and home power network 28, respectively, to create a more permanent connection between the power switching unit 18 and the power grid 12 and home power network 28. Alternatively, the power grid port 20 and home port 26 may include plug-type connectors which allow for more rapid connection/disconnection of the power switching unit 18 to the power grid 12 and home power network 28. The ability to rapidly connect and disconnect the power switching unit 18 facilitates the deployment of the power switching unit 18 in times of emergency, for example in an event of widespread power loss. The vehicle port 22 may include a plug-type connector configured to detachably engage with the charging port/outlet on the electrical vehicle 16. The vehicle port 22 may be required to comply with one or more standards associated with rechargeable vehicles. For instance, in one example embodiment of the present disclosure, the vehicle port 22 is an IEC 62196 compliant connector, although other connectors known in the art may also be used.

According to one embodiment of the present disclosure, the power grid port 20 may be configured to receive A.C. power having a voltage magnitude in a range of 100 to 240 Volts, at a current in the range of 32 to 64 Amps from the power grid 12 Likewise, the vehicle port 22 may be configured to transmit and receive A.C. power at a voltage magnitude in a range of 100 to 240 Volts, at a current in the range of 32 to 64 Amps to and from the vehicle power network 24. Those skilled in the art will recognize that the foregoing values are exemplary in nature only, and that the parameters may change depending on the infrastructure of the power grid 12, the vehicle power network 24 and the home power network 28.

The power grid port 20, the vehicle port 22, and the home port 26 are each in electrical communication with a switch 30 that is capable of routing electrical power between the ports 20, 22, 26; optionally, the switch 30 is implemented as a mechanical contactor or high-power electromagnetic relay, or alternatively using high-voltage semiconductor switching devices. The switch 30 is configured to be transitional between a first position and a second position. In the first position, the switch 30 places the power grid port 20 in electrical communication with the vehicle port 22 and the home port 26 to enable the power grid 12 to provide power to the vehicle power network 24 and the home power network 28. In the second position, the switch 30 places the vehicle port 22 in electrical communication with the home port 26, to allow the electrical vehicle 16 to provide power to the home port 26. During normal operational conditions, the power switching unit 18 will draw power from the power grid 12 to provide charging power to the electrical vehicle 16 and to the home 14 by way of the vehicle port 22 and home port 26, respectively. In this respect, during normal operating conditions, the power from the power grid 12 is supplied to both the home 14 and the vehicle 16. However, in the event of a power outage on the power grid 12, the power switching unit 18 is capable of supplying stored electrical energy in the vehicle 16 to the home 14. In this respect, the power switching unit 18 allows the vehicle 16 to serve as the primary power feed to the home 14, at least for a limited period of time, for example in a manner as described in the foregoing. Once power on the power grid 12 is made available again, the switch 30 may transition from the second position back to the first position, to draw power from the power grid 12 and supply power to the home 14 and the vehicle 16. According to one example embodiment pursuant to the present disclosure, the switch 30 may be configured to isolate the vehicle 16 and home 14 from the downed power grid 12 by isolating the grid power port 20 from the vehicle port 22 and the home port 26 when the switch 30 is in the second position. Once the switch 30 transitions back to the first position, the communication between the power grid 12, the electrical vehicle 16, and the home 14 may be restored by placing the power grid port 20 in communication with the vehicle port 22 and the home port 26.

Operation of the switch 30 may be controlled by a controller 32, which is in communication with the switch 30, the ports 20, 22, 26, as well as various input devices and one or more sensors (for example, a plurality of sensors), as will be explained below. According to one example embodiment pursuant to the present disclosure, the power switching unit 18 includes a power grid sensor 34 capable of detecting the power supplied from the power grid 12, as well as a loss of power from the power grid 12. The power grid sensor 34 may be integrated into the power grid port 20 or may be formed separate from the power grid port 20. The power grid sensor 34 is in communication with the controller 32 to provide the controller 32 with status information regarding power received from the power grid 12. In particular, when power is received from the power grid 12, the power grid sensor 34 detects the power and generates a POWER RECEIVED signal, which is then sent to the controller 32. If the sensor 34 detects a loss of power, the sensor 34 generates a NO POWER signal, which is then sent to the controller 32. When the controller 32 receives the POWER RECEIVED signal, the controller 32 generates a FIRST POSITION command signal, which is transmitted to the switch 30. The switch 30 is configured to assume the first position in response to receipt of the FIRST POSITION command signal. When the controller 32 receives the NO POWER signal from the power grid sensor 34, the controller 32 generates a SECOND POSITION command signal, which is transmitted to the switch 30. The switch 30 is configured to assume the second position in response to receipt of the SECOND POSITION command signal. According to one example embodiment pursuant to the present disclosure, the controller 32 automatically generates the FIRST POSITION command signal in response to receipt of the POWER RECEIVED signal, and the SECOND POSITION command signal in response to receipt of the NO POWER signal. In other words, the FIRST and SECOND POSITION command signals may be generated without any input by the user.

According to another embodiment, the power switching unit 18 may include a manual input circuit 36 in electrical communication with the controller 32 and adapted to allow a user to selectively transition the switch 30 between the first and second positions via manual input (for example, by pressing a button on the power switching unit 18). Along these lines, the manual input circuit 36 may generate and transmit FIRST POSITION and SECOND POSITION command signals to the controller 32 in response to respective inputs received from the user via the manual input circuit 36 for selectively positioning the switch 30. The manual input circuit 36 may be associated with a switch, dial, keypad, physical button or a virtual button on a touch screen display, and so forth, located on the power switching unit 18.

According to another embodiment, the power switching unit 18 may include a wireless input circuit 38 in electrical communication with the controller 32 and adapted to allow a user to provide input commands to the power switching unit 18 via wireless communication. The ability to wirelessly communicate control signal may be desirable for allowing the user to control operation of the power switching unit 18 via a mobile communication device 40 (for example, from a smartphone, a tablet computer, and similar data processing devices). In this regard, the wireless input circuit 38 may be capable of transmitting and receiving wireless signals in several different wireless protocols, including, but not limited to WiFi, Bluetooth™ GSM communications, or other wireless protocols known in the art. When the power switching unit 18 is used with a smartphone 40, the user may download a smart phone software application (namely, an “app.”) which provides the software on the smartphone 40 necessary for operating the power switching unit 18. Along these lines, when the app. is downloaded onto the smartphone 40, the user can selectively generate and transmit FIRST POSITION and SECOND POSITION command signals which are received by the wireless input circuit 38 and relayed to the controller 32 for selectively positioning the switch 30.

Optionally, when using the power switching unit 18 during a loss of power from the power grid 12, a user may not want to drain completely all of the power from the vehicle 16. In this respect, the user may want to leave enough power in the vehicle 16 to drive the vehicle 16 a preset minimum number of miles (for example, to drive the electrical vehicle 16 for a range of 35 miles). Optionally, the electrical vehicle 16 may come equipped with a built-in shutoff feature, which prevents the further drawing of power therefrom once the stored power levels in the electrical vehicle 16 reaches a prescribed minimum power level. However, if the electrical vehicle 16 is not equipped with such a feature, the power switching unit 18 may include a shutoff circuit 40 which monitors the power level in the electrical vehicle 16 and instructs the controller 32 to cease drawing power from the electrical vehicle 16 when the power level in the electrical vehicle 16 reaches the prescribed minimum power level.

In one embodiment, the power switching unit 18 includes a plurality of vehicle ports that are connectable to multiple vehicle power networks associated with multiple vehicles. It may be appreciated that in such instance, the switch 30 associated with the power switching unit 18 may be operable to be placed in more than two positions, for example, a first position, a second position and a third position. For example, the power switching unit 18 may include two vehicle ports that are connectable to two vehicle power networks associated with two electrical vehicles. During power outage, the switch may assume the second position from the first position to draw power from one of the electrical vehicles (such as the electrical vehicle 16). Furthermore, a user may not want to completely drain all of the power from either of the vehicles. In such instance, the shutoff circuit (such as the shutoff circuit 40) associated with the power switching unit 18 monitors the power level in the electrical vehicle and instructs the controller 32 to cease drawing power from the electrical vehicle when the power level in the electrical vehicle reaches the prescribed minimum power level, and further instructs the switch 30 to assume the third position to draw power from the other electrical vehicle. Alternatively, the vehicle port 22 may be connectable to multiple vehicle power networks associated with multiple vehicles. In such instance, during loss of power from the power grid 12, the power switching unit 18 may be placed in the second position to draw power (alternately or simultaneously) from the multiple vehicles.

The power switching unit 18 may include a built-in display 42 for providing information, preferably in a digital format, related to the energy usage from the power grid 12 when the switch 30 is in the first position, and energy drawn from the electrical vehicle 16 when the switch 30 is in the second position.

The power switching unit 18 may further include a built-in voltage regulator and power surge safety mechanism 44 for protecting the power switching unit 18, as well as the home 14 and electrical vehicle 16 coupled to the power switching unit 18. In such instance, the power switching unit 18 may include a shutoff feature to cease operation of the switching unit 18 and prevent damage to the home 14, the electrical vehicle 16 and/or the power switching unit 18.

According to one example embodiment of the present disclosure, the controller 32 may be configured not only to control the communication of power between the power switching unit 18 and the electrical vehicle 16, but also the communication of data therebetween. In this respect, the power switching unit 18 may include a data transceiver 46 which is operatively connectable to a corresponding transceiver located on the electrical vehicle 16. The controller 32 may have a database of stored communication protocols which enable communication with a number of different electrical vehicles 16, for example a fleet including a plurality of such electrical vehicles, for example a taxi firm or a delivery firm.

The power switching unit 18 may further include a retractable power cable with a line overheat temperature sensor with safety cut-off to prevent overheating of the cable. It may be evident that heat is generated during power flow through a cable. Furthermore, the heat generated in the cable may not be adequately dissipated, for example, when the cable is coiled. In this respect, the cable is required to be fully extended before charging or discharging can start. Alternatively, the safety cut-off feature may interrupt (or cut-off) power supply through the coiled cable during charging or discharging. This safety feature is intended to mitigate overheating by a coiled cable.

As an alternative to employing one or more cables to connect from the ports 20, 22 and 26 to the power grid 12 and to the home 14, one or more of the ports 20, 22 and 26 can alternatively be resonant inductively coupled. For example, the electrical vehicle 16 includes resonant inductive coils as a part of its structure that, when held in proximity to other resonant inductive coils, is capable of transferring, for example, 100 kW of power at a resonant inductive frequency in a range of 30 kHz to 300 kHz, with a coupling efficiency that can approach 97%, from practical experience. Such resonant inductive coupling enables the electrical vehicle 16 to be driven into a garage of the home 14 and automatically implement connection of the ports 20, 22 and 26, without a need for the user to couple any power cables. Such inductively coupled coils beneficially are implemented as a series of mutually matched series resonant LC circuits whose windings are overlapping and shielded externally by a thin Aluminum or Copper screen to contain stray magnetic fields, to prevent persons being exposed to a resonant inductive magnetic field generated when coupling power via one or more of the ports 20, 22 and 26, in operation. Designs for such resonant inductive coils are described in great detail in a published patent application WO2013/091875A2 (“Inductive Power Coupling Systems for Roadways”, inventors: Dames and Howe, Applicant: Ampium Ltd.), whose contents are hereby incorporated by reference.

Although the foregoing describes the use of the power switching unit 18 for drawing power from the electrical vehicle 16 and supplying such power to a home 14 in the event of power loss from the power grid 12, the power switching unit 18 is optionally also adapted to allow power to be drawn from the electrical vehicle 16 even if power is not lost from the power grid 12. In this respect, a user may choose to draw power from the electrical vehicle 16 by inputting a command through one of the input circuits 36, 38 described above. When power is drawn from the electrical vehicle 16, the switch 30 may isolate the power grid 12, even though the power grid 12 is capable of providing power. According to an embodiment, the power switching unit 18 includes a plurality of vehicle ports that are connectable to multiple vehicle power networks associated with multiple vehicles. In such an instance, power from one of the vehicles may be provided for charging at least one of the multiple vehicles. For example, a user may possess multiple vehicles and at least one of the vehicles may be in a (partially or completely) charged state and another vehicle in a completely discharged state. In such instance, the user may draw power from the one or more vehicles in a charged state to charge the vehicle in the discharged state. Alternatively, the user may draw power from a vehicle associated therewith to charge one or more electrical vehicles associated with another user (such as a neighbor). When the user wants to switch back to the power grid 12, the user may once again use one of the input circuits 36, 38. Optionally, the user may select a pre-programmed schedule for drawing power from the electrical vehicle 16. For instance, the user may instruct the power switching unit 18 to draw power from the electrical vehicle 16 for a prescribed period of time, and then switch back to drawing power from the power grid 12. Alternatively, the user may instruct the power switching unit 18 to draw power from one electrical vehicle for a prescribed period of time, and then switch to drawing power from another electrical vehicle for another prescribed period of time. For instance, some utility companies place a premium on electricity during certain times of the day. Therefore, a user may instruct the power switching unit 18 to draw power from the electrical vehicle 16 during those premium hours, based upon the condition that the electrical vehicle 16 is connected to the power switching unit 18, and then switch back to drawing power from the power grid 12 when the rates have dropped. In such instance, the data processing system of the home 14 may communicate with the data processing arrangement (“SAMI”) of the electric vehicle 16 to determine an amount of power stored in the electrical vehicle 16. Furthermore, upon determining that the electrical vehicle is connected to the power switching unit 18, power may be drawn from the electrical vehicle according to the pre-programmed schedule, in response to the electrical vehicle 16 having sufficient stored power. Alternatively, upon determining that the electrical vehicle is not connected to the power switching unit 18, a location of the electrical vehicle 16 and the amount of power stored therein may be determined.

Although the foregoing describes the power switching unit 18 for use in connection with a residential home, it is understood that the term “home” as used herein may refer broadly to any facility having a dedicated power network. In this respect, the power switching unit 18 may be used at a commercial facility for providing backup power via one or more such electrical vehicles 16. This may be particularly beneficial for a company which owns a fleet of such electrical vehicles 16, wherein the fleet of such electrical vehicles 16 may collectively supply power to the commercial facility in the event of a grid power loss.

Optionally, it will be appreciated that the owner of the electrical vehicle 16, namely the user, is able to enter into a commercial contract with an operator of the power grid 12 to provide demand response to the power grid 12, for example:
(i) by way of a rate of recharging the battery, or the plurality of batteries, of the electrical vehicle 16 being made dependent upon an overall power load on the power grid 12; and/or
(ii) the electrical vehicle 16 is operable to supply power from its battery, or its plurality of batteries, back to the power grid 12 to function as a power resource when the power grid 12 is heavily loaded, or in an event of a power generator supplying power to the power grid 12 becoming non-functional or disconnected (for example, a power generator breakdown, a nuclear reactor meltdown).

The commercial contract involves the owner of the electrical vehicle 16 receiving a regular payment for making his/her electrical vehicle 16 available for providing demand response, or receiving a payment in proportion to an amount of demand response provided by the owner. The provision of such demand response can be coordinated from an operator of the power grid 12, or at the electrical vehicle 16 itself, when a frequency and/or a magnitude of power provided from the power grid 12 exceeds, or falls below, a predefined threshold, for example when the A.C. operating frequency of the power grid 12 falls below 49.5 Hz, when the power grid 12 has a nominal A.C. operating frequency of 50.0 Hz; alternatively, for example, when the magnitude of voltage of power grid 12 falls below 10% of its nominal magnitude. In such case, when feeding power from the electrical vehicle 16 back to the power grid 12, the electrical vehicle 16 is operable to synthesize an A.C. power signal that is fed into the power grid 12 in frequency synchronism with the power grid 12 to provide the demand response. The synthesized A.C. signal can either be in-phase (namely, 0o phase relationship) with the power grid 12 but at a slightly greater magnitude to provide for power flow into the power grid 12, and/or the synthesized A.C. signal can be in phase lead (namely, >0o phase relationship) relative to the power grid 12 to provide for power flow into the power grid 12. An amount of demand response provided by the electrical vehicle 16 is monitored from the electrical vehicle 16 and communicated to the operator of the power grid 16 for financial accounting purposes. Optionally, the operator of the power grid 16 is operable to send early warnings of potential overload of the power grid 12 arising, so that the electrical vehicle 16 is operable to charge its battery, or its plurality of batteries, to a greater extent in anticipation of providing demand response during the potential overload. Such a demand response is especially useful when employing renewable energy systems whose power generation may be randomly influenced by ambient weather conditions (for example, as a function of wind speed, precipitation, cloud cover, and so forth). As an alternative to the user being paid financially for providing demand response, the user can be provided with power credits that can be used when recharging the electrical vehicle 16 later. Optionally, the owner of the electrical vehicle 16 is able to control, or to specify to the operator of the power grid 12, a magnitude of demand response that is allowed to be provided from the electrical vehicle 16 to the power grid 12, and also when the demand response is to be provided to the power grid 12 (for example, in anticipation of likely use the owner will make of his/her electrical vehicle 16), so that a high degree of demand response is not provided immediately before the owner is planning to use his/her electrical vehicle 16 to travel a long distance, to avoid the battery, or the plurality of batteries, of the electrical vehicle 16 not being in a discharged state, or partially discharge state, (for example, being in excess of 90% charged) when the owner intends to travel using the electrical vehicle 16.

The particulars shown herein are by way of example only for purposes of illustrative discussion, and are not presented in the cause of providing what is believed to be most useful and readily understood description of the principles and conceptual aspects of the various embodiments of the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. A power switching unit adapted for use with a power grid, a home power network, and a vehicle having a vehicle power network, the power switching unit comprising:
a first power port configured to be connectable to the power grid to receive power therefrom;
a second power port configured to be connectable to the vehicle power network of the vehicle;
a third power port configured to be connectable with the home power network;
a switch in electrical communication with the first power port, the second power port, and the third power port, the switch being transitional between a first position operative to place the first power port in electrical communication with the second power port and the third power port to enable the power grid to provide power to the vehicle power network and the home power network, and a second position operative to place the second power port in electrical communication with the third power port to allow the vehicle to provide power to the house power port, and
wherein the power switching unit is operable to couple the vehicle power network to the power grid, for providing demand response to the power grid.

2. The power switching unit recited in claim 1, wherein at least one of the power ports is implemented using resonant inductive power transfer.

3. The power switching unit recited in claim 1, wherein the power switching unit is operable to couple a synthesized A.C. power signal via the third power port to the home, wherein the synthesized A.C. power signal is generated from power delivered from the vehicle power network.

4. The power switching unit recited in claim 1, wherein:
the first power port is configured to detect a power loss from the power grid; and
the switch is configured to switch automatically from the first position to the second position in response to a detected power loss by the first power port.

5. The power switching unit recited in claim 4, wherein the switch is configured to switch automatically from the second position to the first position in response to detection of power from the power grid.

6. The power switching unit recited in claim 4, wherein the switch is at least one of a mechanical contactor, a high-power electromagnetic relay, or a high-voltage semiconductor switching device.

7. The power switching unit recited in claim 1, wherein the switch is configured to electrically isolate the first power port from the second power port and the third power port when the switch is in the second position.

8. The power switching unit recited in claim 1, wherein the second power port is an IEC 62196 connector.

9. The power switching unit recited in claim 1, further comprising a user input circuit adapted to receive a switch signal from a user, the switch being configured to switch positions in response to receipt of the switch signal.

10. The power switching unit recited in claim 9, wherein the user input circuit includes a wireless communication circuit capable of receiving the switch signal via wireless communication.

11. The power switching unit recited in claim 1, wherein the first power port is configured to receive 100-240V AC from the power grid.

12. The power switching unit recited in claim 1, wherein the second power port is configured to:
transmit 100-240V AC to the vehicle power network when the switch is in the first position; and
receive 100-240V AC from the vehicle power network when the switch is in the second position.

13. The power switching unit recited in claim 1, further comprising a control unit capable of generating a command signal to the vehicle power network to provide power to the second power port.

14. A method of managing communication of electrical power between a power grid, a vehicle power network, and a home power network, the method comprising the steps of:
(a) receiving electrical power from the power grid at a first power port;
(b) delivering electrical power received from the power grid to:
a second power port adapted to communicate electrical power to the vehicle power network for charging the vehicle; and
a third power port adapted to communicate electrical power to the home power network;
(c) detecting a loss of electrical power from the power grid at the first power port;
(d) receiving electrical power from the vehicle power network at the second power port subsequent to the detected loss of electrical power from the power grid;
(e) delivering the electrical power received at the second power port to the third power port; and
(f) coupling the vehicle power network to the power grid, for providing demand response to the power grid.

15. The method recited in claim 14, wherein the method includes implementing at least one of the power ports using resonant inductive power transfer.

16. The method recited in claim 14, wherein the method includes operating the power switching unit to couple a synthesized A.C. power signal via the third power port to the home, wherein the synthesized A.C. power signal is generated from power delivered from the vehicle power network.

17. The method recited in claim 14, wherein step (d) proceeds automatically in response to the detected loss of power in step (c).

18. The method recited in claim 14, further comprising the steps of:
(f) detecting electrical power from the power grid at the first power port subsequent to a loss of power from the power grid at the first power port; and
(g) ceasing the receipt of electrical power from the vehicle power network in response to the detected electrical power from the power grid in step (e).

19. The method recited in claim 14, wherein step (d) comprises electrically isolating the first power port from the second power port and the third power port when electrical power is received from the vehicle power network.

20. The method recited in claim 14, wherein step (b) comprises delivering electrical power to a second power port which is an IEC 62196 connector.

21. The method recited in claim 14, wherein steps (d) and (e) are alternatively triggered by the receipt of a switch signal at a user input circuit in operative electrical communication with the first, second and third power ports.

22. The method recited in claim 21, wherein steps (d) and (e) are alternatively triggered by the receipt of a wireless signal at a user input circuit in operative electrical communication with the first, second and third power ports.

23. The method recited in claim 14, wherein step (a) comprises receiving 100-240V AC from the power grid.

24. The method recited in claim 14, wherein:
step (b) comprises transmitting 100-240V AC to the vehicle power network; and
step (d) comprises receiving 100-240V AC from the vehicle power network.

25. The method recited in claim 14, wherein step (d) comprises generating a command signal for transmission to the vehicle power network to provide power to the second power port in response to the detected loss of electrical power from the power grid in step (c).

26. The method recited in claim 14, further comprising receiving payment for providing demand response to the power grid.

27. A power switching unit adapted for use with a power grid, a home power network, and a vehicle having a vehicle power network, the power switching unit comprising:
a first power port configured to be connectable to the power grid to receive power therefrom;
a second power port configured to be connectable to the vehicle power network of the vehicle;
a third power port configured to be connectable with the home power network;
a switch in electrical communication with the first power port, the second power port, and the third power port, the switch being transitional between a first position operative to place the first power port in electrical communication with the second power port and the third power port to enable the power grid to provide power to the vehicle power network and the home power network, and a second position operative to place the second power port in electrical communication with the third power port to allow the vehicle to provide power to the house power port, and
wherein at least one of the power ports is implemented using resonant inductive power transfer.

28. The power switching unit recited in claim 27, wherein at least one of the power ports is configured to transfer power at a resonant inductive frequency in a range of 30 kHz to 300 kHz.

29. A method of managing communication of electrical power between a power grid, a vehicle power network, and a home power network, the method comprising the steps of:
(a) receiving electrical power from the power grid at a first power port;
(b) delivering electrical power received from the power grid to:
a second power port adapted to communicate electrical power to the vehicle power network for charging the vehicle using resonant inductive power transfer; and a third power port adapted to communicate electrical power to the home power network;
(c) detecting a loss of electrical power from the power grid at the first power port;
(d) receiving electrical power from the vehicle power network at the second power port using resonant inductive power transfer subsequent to the detected loss of electrical power from the power grid; and
(e) delivering the electrical power received at the second power port to the third power port.

30. The method recited in claim 29, wherein:
step (b) comprises transmitting power at a resonant inductive frequency in a range of 30 kHz to 300 kHz to the vehicle power network; and
step (d) comprises receiving power at a resonant inductive frequency in a range of 30 kHz to 300 kHz from the vehicle power network.

31. A power switching unit adapted for use with a power grid, a home power network, and a vehicle having a vehicle power network, the power switching unit comprising:
a first power port configured to be connectable to the power grid to receive power therefrom;
a second power port configured to be connectable to the vehicle power network of the vehicle;
a third power port configured to be connectable with the home power network;
a switch in electrical communication with the first power port, the second power port, and the third power port, the switch being transitional between a first position operative to place the first power port in electrical communication with the second power port and the third power port to enable the power grid to provide power to the vehicle power network and the home power network, and a second position operative to place the second power port in electrical communication with the third power port to allow the vehicle to provide power to the house power port, and
wherein the power switching unit is operable to couple a synthesized A.C. power signal via the third power port to the home, and wherein the synthesized A.C. power signal is generated from power delivered from the vehicle power network.

32. The power switching unit recited in claim 31, wherein the synthesized A.C. power signal is synthesized using one or more semiconductor power modules of the vehicle.

33. The power switching unit recited in claim 32, wherein the one or more power semiconductor power modules employ a high-frequency switching circuit.

34. The power switching unit recited in claim 33, wherein the high-frequency switching circuit is at least one of: MOSFET, Silicon Carbide FET.

35. The power switching unit recited in claim 31, wherein the synthesized A.C. power signal has a frequency in a range of 50 Hz to 60 Hz.

36. A method of managing communication of electrical power between a power grid, a vehicle power network, and a home power network, the method comprising the steps of:
(a) receiving electrical power from the power grid at a first power port;
(b) delivering electrical power received from the power grid to:
a second power port adapted to communicate electrical power to the vehicle power network for charging the vehicle; and
a third power port adapted to communicate electrical power to the home power network;
(c) detecting a loss of electrical power from the power grid at the first power port;
(d) receiving electrical power from the vehicle power network at the second power port subsequent to the detected loss of electrical power from the power grid;
(e) generating a synthesized A.C. power signal from the electrical power received from the vehicle power network at the second power port; and
(f) delivering the synthesized A.C. power signal from the second power port via the third power port to the home.

37. The method recited in claim 36, wherein the synthesized A.C. power signal is generated using one or more semiconductor power modules of the vehicle.

38. The method recited in claim 37, wherein the one or more power semiconductor power modules employ a high-frequency switching circuit.

39. The method recited in claim 38, wherein the high-frequency switching circuit is at least one of: MOSFET, Silicon Carbide FET.

40. The method recited in claim 36, wherein the synthesized A.C. power signal has a frequency in a range of 50 Hz to 60 Hz.

41. A power switching unit adapted for use with a power grid, a home power network, and a vehicle having a vehicle power network, the power switching unit comprising:
a first power port configured to be connectable to the power grid to receive power therefrom;
a second power port configured to be connectable to the vehicle power network of the vehicle;
a third power port configured to be connectable with the home power network;
a switch in electrical communication with the first power port, the second power port, and the third power port, the switch being transitional between a first position operative to place the first power port in electrical communication with the second power port and the third power port to enable the power grid to provide power to the vehicle power network and the home power network, and a second position operative to place the second power port in electrical communication with the third power port to allow the vehicle to provide power to the house power port, and
wherein the power switching unit includes a data communication interface for receiving remote instructions for controlling coupling of the first, second and third power ports.

42. A power switching unit of claim 41, wherein the data communication interface is operable to receive the remote instructions generated by a software application that is executable upon computing hardware of a mobile wireless communication device.

43. A power switching unit of claim 42, wherein the switch is at least one of a mechanical contactor, a high-power electromagnetic relay, or a high-voltage semiconductor switching device.

44. A method of managing communication of electrical power between a power grid, a vehicle power network, and a home power network, the method comprising the steps of:
(a) receiving electrical power from the power grid at a first power port;
(b) delivering electrical power received from the power grid to:
a second power port adapted to communicate electrical power to the vehicle power network for charging the vehicle; and
a third power port adapted to communicate electrical power to the home power network;
(c) receiving a remote instruction from a data communication interface to electrically isolate the first power port from the second power port and the third power port;
(d) receiving electrical power from the vehicle power network at the second power port in response to receipt of the remote instruction from the data communication interface; and
(e) delivering the electrical power received at the second power port to the third power port.

45. The method recited in claim 44, wherein the remote instruction is a switch signal.

46. The method recited in claim 45, wherein the first power port is electrically isolated from the second power port and the third power port using a switch in electrical communication with the first power port, the second power port, and the third power port, the switch being transitional between a first position operative to place the first power port in electrical communication with the second power port and the third power port to enable the power grid to provide power to the vehicle power network and the home power network, and a second position operative to place the second power port in electrical communication with the third power port to allow the vehicle to provide power to the house power port, wherein the switch is configured to electrically isolate the first power port from the second power port and the third power port when the switch is in the second position.

47. The method recited in claim 46, wherein the switch is at least one of a mechanical contactor, a high-power electromagnetic relay, or a high-voltage semiconductor switching device.
